(19) United States
(12) Patent Application Publication
(10) Pub. No.: US 2002/0061940 A1
(43) Pub. Date: May 23, 2002

(54) Water-based, pigmented coating compositions

(76) Inventors: Christian Lach, Bad Durkheim (DE); Roland Baumstark, Neustadt (DE)

Correspondence Address: Herbert B. Keil, KEIL & WEINKAUF, 1101 Connecticut Ave., N.W., Washington, DC, 20036, US

(21) Appl. No.: 09/972,253

(22) Filed: Oct. 9, 2001

(30) Foreign Application Priority Data
Oct. 9, 2000 (DE) 10049791.8

(51) Int. Cl. C09D 5/00

(52) U.S. Cl. 523/160; 523/161

(57) ABSTRACT

Described is a water-based, pigmented coating composition essentially free from volatile organic compounds and comprising

i) an aqueous binder formulation as component I, with a minimum film formation temperature MFFT≦5° C., based on an aqueous polymer dispersion of one or more polymers P composed of the monomers specified in claim 1,

ii) at least one inorganic particulate pigment as component II,

iii)if desired, inorganic particulate fillers as component III, and

iv) the auxiliaries typical of coating compositions, the coating composition containing less than 0.05% by weight, based on the polymer P, of photoinitiators and being characterized by a pigment volume concentration PVC of more than 20.

The present invention relates to water-based, pigmented coating compositions which comprise at least one aqueous dispersion of a film-forming polymer P as binder and which are essentially free from organic, water-insoluble solvents and film-forming auxiliaries.

Pigmented coating compositions, here and below, are, in particular, paints and synthetic-resin-bound plasters. Pigmented aqueous coating compositions generally include a film-forming polymer in the form of an aqueous polymer dispersion as a binder for the pigment particles and any fillers that may be present. When the coating dries, the polymer particles present in the polymer dispersion form a polymer film which binds the pigment particles and the fillers. The development of a uniform polymer film is only ensured when the coating composition is processed at temperatures above the minimum film formation temperature (MFFT; the temperature above which the polymer in the coating composition forms a polymer film). Uniform filming, however, is important for the mechanical stability of the coating. Conventional coating compositions therefore generally include film-forming auxiliaries which lower the film formation temperature of the polymer. The film-forming auxiliaries (coalescants) are generally volatile organic compounds, examples being solvents such as hydrocarbons, glycols and glycol ethers, or plasticizers, examples being dialkyl esters of dicarboxylic acids, which initially plastify the polymer particles during drying of the coating (temporary plastification) and so facilitate film formation. On further drying, the film-forming auxiliaries are emitted to the ambient atmosphere, as a result of which the surface hardness of the polymer film is increased and its tackiness is reduced. The emission of such volatile substances, normally referred to as VOCs (volatile organic compounds), to the ambient atmosphere is undesirable, and so film-forming auxiliaries and other volatile constituents should be avoided in pigmented aqueous coating compositions.

Binders which have a sufficiently low MFFT even without coalescants frequently lead to coatings whose mechanical strength is poor owing to the relatively low cohesion of the polymer film. Moreover, such coatings exhibit an increased soiling tendency.

A further problem is the weathering stability of coatings obtained from low-solvent, water-based coating compositions. Severe temperature fluctuations and moisture exposure may result in cracking and delamination of the coating (e.g., blistering). A particular problem is the effect of water and frost, i.e., frost exposure in a humid atmosphere. Under such conditions, coatings based on conventional, low-solvent coating compositions frequently suffer delamination, which is manifested by blistering, cracking and—in extreme cases—by flaking of the coating.

U.S. Pat. No. 5,530,056 and U.S. Pat. No. 5,610,225 disclose binders for solvent-free aqueous coating compositions, containing special esters of acrylic acid or methacrylic acid with polyethylene glycols (PEG monomers) in copolymerized form. PEG monomers are comparatively expensive and their effect is not always satisfactory.

EP-A 810 274 describes the use of copolymers of vinyl-aromatic monomers with alkyl acrylates as binders in pigmented or filled coating compositions. Coatings based on the binders described therein have a high wet abrasion resistance especially when the binder polymer contains less than 1% by weight of acidic monomers in copolymerized form. The coatings thus obtained feature only average weathering stability and soiling tendency, especially under prolonged UV radiation exposure.

DE 198 11 314 describes coating compositions whose wet abrasion resistance is improved by the presence of a binder polymer containing from 0.1 to 1.5% by weight of itaconic acid in copolymerized form.

EP-A 599 676 describes latex paint binders comprising aqueous polymer dispersions which comprise polymerizable derivatives of benzophenone in copolymerized form. The use of special monomers of this kind likewise increases the costs of the binder to a considerable extent.

The German patent application P 199 18 052.0 describes water-based coating compositions which are essentially solvent-free. To reduce their soiling tendency, the coating compositions contain from 0.05 to <0.3% by weight of photoinitiators.

The earlier German patent applications P 199 39 327.3 describes binder polymers based on styrene/(meth)acrylate polymers containing from 2 to 4% by weight of methacrylic acid in copolymerized form, and their use as binders in emulsion paints, i.e., water-based paint compositions.

It is an object of the present invention to provide coating compositions which are essentially solvent-free and provide a mechanically stable coating which, moreover, is stable under weathering conditions such as UV radiation and frost exposure.

We have found that this object is achieved by coating compositions whose binder comprises an aqueous polymer dispersion of a polyacrylate containing in copolymerized form from 0.1 to 10% by weight of the polar auxiliary monomers B to E, defined below, the fraction of ethylenically unsaturated monocarboxylic acids accounting for less than 1% by weight of the overall monomer amount.

The present invention accordingly provides a water-based, pigmented coating composition essentially free from volatile organic compounds and comprising

i) an aqueous binder formulation as component I, with a minimum film formation temperature MFFT <5° C., based on an aqueous polymer dispersion of one or more polymers P composed of

from 90 to 99.9% by weight of at least two different monomer varieties A1 and A2, the monomer A1 being selected from the C₂-C₁₂ alkyl esters of acrylic acid and the monomer A2 being selected from the C₁-C₁₂ alkyl esters of methacrylic acid;

from 0 to <1% by weight of monomers B, selected from monoethylenically unsaturated monocarboxylic acids having 3 to 6 carbon atoms;

from 0 to 0.5% by weight of monomers C, selected from monoethylenically unsaturated dicarboxylic acids having 4 to 6 carbon atoms and ethylenidally unsaturated sulfonic acids;

from 0 to 2% by weight of monomers D, selected from the amides of monoethylenically unsaturated monocarboxylic acids having 3 to 6 carbon atoms;

from 0 to 5% by weight of monomers E, selected from the C₂-C₄ hydroxyalkyl esters of monoethylenically unsaturated monocarboxylic acids having 3 to 6 carbon atoms (monomers E1) and the esters of monoethylenically unsaturated monocarboxylic acids having 3 to 6 carbon atoms with poly(C₂-C₃ alkylene oxides) (monomers E2), and monomers F, selected from monoethylenically unsaturated monomers having a urea group and monoethylenically unsaturated monomers having an acetylacetoxy group,

all proportions of the monomers being based on the overall amount of the monomers A to F; the overall amount of the monomers B and C being less than 1% by weight, and the overall amount of the monomers B, C, D, E and F being from 0.1 to 10% by weight, preferably from 0.2 to 5% by weight, and in particular from 0.3 to 2% by weight;

ii) at least one inorganic particulate pigment as component II,

iii) if desired, inorganic particulate fillers as component III, and

iv) the auxiliaries typical of coating compositions, the coating composition containing less than 0.05% by weight, based on the polymer P, of photoinitiators and being characterized by a pigment volume concentration PVC of more than 20.

In the coating compositions of the invention, the amount of volatile organic solvents and film-forming auxiliaries is generally less than 0.1% by weight, in particular less than 500 ppm and, especially, not more than 300 ppm, based on the overall weight of the coating composition. Examples of organic solvents and film-forming auxiliaries are volatile hydrocarbons such as petroleum fractions, white oils, liquid paraffins, glycols such as butylene glycol, ethylene glycol, diethylene glycol and propylene glycol, glycol ethers such as glycol butyl ether, diethylene glycol monobutyl ether, 1-methoxy-2-propanol, dipropylene glycol methyl ether, dipropylene glycol propyl ether, dipropylene glycol n-butyl ether, tripropylene glycol-n-butyl ether, 2/3-phenoxypropanol, glycol esters and glycol ether esters such as butyl glycol acetate, diethylene glycol mono-n-butyl ether acetate, 2,2,4-trimethylpentane-1,3-diol monoisobutyrate and the like, and organic plasticizers (organic liquids having a boiling point above 250° C.), such as dibutyl phthalate, dioctyl phthalate, tributoxyoctyl phosphate, 2,2,4-trimethylpentane-1,3-diol diisobutyrate and polypropylene glycol alkylphenyl ethers (e.g., Plastilit®3060) and—deriving from their preparation—unpolymerized monomers (known as residual monomers). Typically, the only water-insoluble organic compounds present in the coating compositions of the invention are volatile organic impurities deriving from their preparation, such as residual monomers and conversion products thereof, advantageously in amounts of less than 1000 ppm and in particular less than 500 ppm and preferably not more than 300 ppm, based on the overall weight of the coating composition.

The pigment volume concentration PVC is defined as 100 times the quotient of the volume fraction of the components II+III and the overall volume of the components I+II+III.

The minimum film formation temperature is the temperature below which a binder no longer forms a uniform, i.e., crack-free, film. The temperatures are determined in accordance with DIN 53787 (see Ullmanns Enzyklopädie der Technischen Chemie, 4th ed., vol. 19, VCH Weinheim 1980, p. 17). Preferably, the MFFT of the binders used in the coating compositions of the invention is below 3° C. and in particular below 0° C. In general, the MFFT is set not by adding coalescence auxiliaries but instead by using a polymer P having a suitable glass transition temperature Tg, since the MFFT is related to the glass transition temperature Tg. Normally, the glass transition temperature of the polymers P is situated in the range from +10 to −20° C. and, in particular, in the range from +10 to −10° C.

In this specification, the term glass transition temperature means the glass transition temperature (cf. ASTM D 3418-82) determined by the DSC (differential scanning calorimetry, 20° C./min, midpoint) method.

In order to set the desired Tg, the skilled worker preparing the polymer P will start from a suitable monomer mixture. According to Fox (T.G. Fox, Bull. Am. Phys. Soc. (Ser. II) 1, 123 [1956] and Ullmanns Enzyklopädie der technischen Chemie, 4th edition, volume 19, Verlag Chemie, Weinheim (1980), p. 17, 18), the glass transition temperature of copolymers at high molecular masses is given in good approximation by

$$\frac{1}{{T}_{G}} = \frac{{X}^{1}}{{T}_{G}^{1}} + \frac{{X}^{2}}{{T}_{G}^{2}} + ⋯ \frac{{X}^{n}}{{T}_{G}^{n}}$$

where X¹, X², . . . , Xⁿ are the mass fractions of the monomers 1, 2, . . . , n and T_{g}¹, T_{g}², . . . , T_{g}ⁿ are the glass transition temperatures of the homopolymers of each of the monomers 1, 2, . . . , n, in degrees Kelvin. Sources of tabulated glass transition temperatures of homopolymers are, for example, Ullmann's Encyclopedia of Industrial Chemistry, ₅th ed., VCH, Weinheim, Vol. A 21 (1992) p. 169 and J. Brandrup, E. H. Immergut, Polymer Handbook 2^{nd} ed., J. Wiley, New York 1975, pp. 139-192.

In accordance with the invention the monomers A, which generally account for at least 90% by weight and preferably at least 95% by weight, in particular at least 98% by weight, of the polymer P, include at least one monomer A1 and at least one monomer A2. Examples of monomers A1 are ethyl acrylate, isopropyl acrylate, n-butyl acrylate, n-hexyl acrylate, n-octyl acrylate, 2-ethylhexyl acrylate and decyl acrylate, preferably ethyl acrylate, n-butyl acrylate and 2-ethylhexyl acrylate. Preferred monomers A2 are the C₁-C₄ alkyl esters of methacrylic acid, especially methyl methacrylate and n-butyl methacrylate. Besides the preferred monomers A2, the polymer P may also contain other alkyl esters of methacrylic acid in copolymerized form, an example being 2-ethylhexyl methacrylate.

In one particularly preferred embodiment of the present invention, the polymer P contains exclusively 2-ethylhexyl acrylate as monomer A1, with particular preference in conjunction with methyl methacrylate as monomer A2. In another preferred embodiment, the polymer P contains n-butyl acrylate as sole monomer A1, or a combination of n-butyl acrylate and 2-ethylhexyl acrylate as monomers A1 in copolymerized form.

The weight ratio of the monomers A1:A2 depends of course on the desired glass transition temperature of the polymer P and thus on the glass transition temperatures of the homopolymers corresponding to the monomers. It is preferably in the range from 2:8 to 8:2, in particular from 3:7 to 7:3, and with particular preference in the range from 6:4 to 4:6.

Particularly suitable monomers B are acrylic acid and methacrylic acid. The polymer P preferably contains not more than 0.8% by weight, for example, from 0.1 to 0.8% by weight, of monomers B, based on the overall weight of the polymer P (or of the monomers A-F).

Examples of monomers C are itaconic acid, maleic acid and fumaric acid as ethylenically unsaturated dicarboxylic acids, and also vinylsulfonic acid, acryloyloxyethylsulfonic acid, methacryloyloxyethylsulfonic acid, 2-acrylamido-2-methylsulfonic acid and 2-methacrylamido-2-methylsulfonic acid, and the salts thereof, especially their alkali metal salts and with particular preference their sodium salts. In one particularly preferred embodiment of the present invention, the polymer P contains monomers B as sole acidic monomers, in copolymerized form. The overall amount of monomers B and C, in accordance with the invention, is below 1% by weight and in particular below 0.8% by weight, based on the overall weight of the polymer P (corresponding to the overall monomer amount A to F).

Furthermore, the polymers P may contain up to 2% by weight of monomers D in copolymerized form, said monomers D being selected from the amides of monoethylenically unsaturated carboxylic acids having 3 to 6 carbon atoms, examples being acrylamide or methacrylamide. In one preferred embodiment of the present invention, the polymers P contain from 0.2 to 2% by weight and in particular from 0.5 to 1.5% by weight of monomers D, in copolymerized form.

Instead or together with the monomers D, the polymers P of the invention may also contain monomers E, copolymerized in an amount of preferably up to 4% by weight. Where the polymer P does contain copolymerized monomers E, their weight fraction, based on the overall amount of the monomers A to E, is preferably in the range from 0.2 to 4% by weight. Where the monomer E comprises a monomer E1, its weight fraction is preferably in the range from 1 to 5% by weight, in particular in the range from 2 to 4% by weight. Where the monomer E comprises a monomer E2, its weight fraction is preferably in the range from 0.2 to 5% by weight, in particular in the range from 0.5 to 4% by weight. Examples of monomers E1 are 2-hydroxyethyl acrylate, 2-hydroxyethyl methacrylate, hydroxypropyl acrylate, hydroxypropyl methacrylate, hydroxybutyl acrylate and hydroxybutyl methacrylate. Examples of monomers E2 are the esters of acrylic acid and also the esters of methacrylic acid with poly(C₂-C₃ alkylene oxides), such as polyethylene oxide, polypropylene oxide and polyethylene oxide/polypropylene oxide block copolymers, the degree of alkoxylation typically being in the range from 2 to 200 and preferably in the range from 5 to 100. Among these, preference is given to the esters of acrylic acid and of methacrylic acid with polyethylene oxides.

Further suitable monomers include monoethylenically unsaturated monomers F, which contain either an acetylacetoxy group or a urea group. Monomers of this kind serve to improve the wet adhesion of the coating and may be present in the binders in an amount of up to 5% by weight, preferably up to 4% by weight, e.g., from 0.1 to 5% by weight, preferably from 0.2 to 4% by weight, in particular from 0.5 to 2% by weight. The monomers F include N-vinylurea and N-allylurea, N-vinyloxyethyl- and N-allyloxyethylimidazolidin-2-one, N-(2-(meth)acrylamidoethyl)- and N-(2-(meth)acryloyloxyethyl)imidazolidin-2-one, as monomers with urea function, and also 2-(2′-acetylacetoxy)ethyl(meth)acrylic ester and N-[2-(21-acetylacetoxy)ethyl](meth)acrylamide, as monomers containing acetylacetoxy groups.

Furthermore, it has proven advantageous for the polymer particles in the binder polymer dispersion to have a weight-average polymer particle diameter in the range from 50 to 500 nm (determined by means of an ultracentrifuge or by photon correlation spectroscopy; regarding particle size determination by means of an ultracentrifuge see, for example W. Machtle, Makromolekulare Chemie 185 (1984) 1025-1039, W. Machtle, Angew. Makromolekulare Chemie 162 (1988) 35-42). In the case of binder dispersions with high solids contents, e.g., >50% by weight, based on the overall weight of the binder dispersion, it is of advantage on viscosity grounds for the weight-average particle diameter of the polymer particles in the dispersion to be ≧100 nm. The average particle diameter will preferably not exceed 300 nm, in particular 200 nm.

The aqueous dispersions of the polymer P are generally prepared by free-radical aqueous emulsion polymerization of the abovementioned monomers A-F in the presence of at least one free-radical polymerization initiator and at least one surface-active substance.

Suitable free-radical polymerization initiators are all those capable of triggering a free-radical aqueous emulsion polymerization. They may include both peroxides, e.g., alkali metal peroxodisulfates, and azo compounds. As polymerization initiators it is common to use what are known as redox initiators, which are composed of at least one organic reductant and at least one peroxide and/or hydroperoxide, e.g., tert-butyl hydroperoxide, with sulfur compounds, e.g., the sodium salt of hydroxymethanesulfinic acid, sodium sulfite, sodium disulfite, sodium thiosulfate or acetone bisulfite adduct, or hydrogen peroxide with ascorbic acid. Use is also made of combined systems, which include a small amount of a metal compound which is soluble in the polymerization medium and whose metallic component is able to exist in a plurality of valence states, an example being ascorbic acid/iron(II) sulfate/hydrogen peroxide, in which the ascorbic acid is frequently replaced by the sodium salt of hydroxymethanesulfinic acid, acetone bisulfite adduct, sodium sulfite, sodium hydrogen sulfite or sodium bisulfite and the hydrogen peroxide by organic peroxides such as tert-butyl hydroperoxide or alkali metal peroxodisulfates and/or ammonium peroxodisulfate. Likewise preferred initiators are peroxodisulfates, such as sodium peroxodisulfate. The amount of free-radical initiator systems used, based on the overall amount of the monomers to be polymerized, is preferably from 0.1 to 2% by weight.

Surface-active substances suitable for conducting the emulsion polymerization are the emulsifiers and protective colloids which are commonly used for these purposes. The surface-active substances are usually used in amounts of up to 20% by weight, based on the monomers A-F (or polymer P). To stabilize the aqueous dispersions of the polymer P, the amount of surface-active substances used will generally be at least 0.5% by weight, preferably at least 1% by weight, and in particular at least 1.5% by weight. The surface-active substances used in preparing the aqueous dispersions of the polymers P may be added to the polymerization reaction during or before the polymerization process. A portion may also be added following the preparation of the polymer dispersion, for the purpose of stabilizing it. Since the surface-active substances remain in the polymer dispersions, they codetermine the properties of the coating compositions of the invention. For this reason, in the coating compositions of the invention it is preferred to use aqueous dispersions of the polymer P which contain not more than 10, in particular not more than 8, and with particular preference not more than 5% by weight of surface-active substances, based on the polymer P.

Examples of suitable protective colloids are polyvinyl alcohols, starch derivatives and cellulose derivatives, or vinylpyrrolidone copolymers. An exhaustive description of further suitable protective colloids is given in Houben-Weyl, Methoden der organischen Chemie, volume XIV/1, Makromolekulare Stoffe, [Macromolecular Substances] Georg-Thieme-Verlag, Stuttgart 1961, pp. 411-420.

As surface-active substances it is preferred to use exclusively emulsifiers, whose relative molecular weights, in contradistinction to those of the protective colloids, are usually below 2000. They may be either anionic or nonionic in nature. The anionic emulsifiers include alkali metal salts and ammonium salts of alkyl sulfates (alkyl: C₈-C₁₂), of mono- and di-C₄-C₁₂ alkyl esters of sulfosuccinic acid, of sulfuric monoesters with ethoxylated alkanols (EO units: 2 to 50, alkyl: C₁₂ to C₁₈) and with ethoxylated alkylphenols (EO units: 3 to 50, alkyl: C₄-C₉), of alkylsulfonic acids (alkyl: C₁₂-C₁₈) and of alkylarylsulfonic acids (alkyl: C₉ to C₁₈), and also compounds of the formula I,

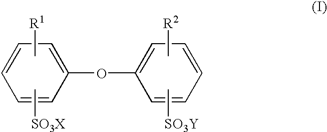

in which R¹ and R² are hydrogen or C₄-C₂₄ alkyl, preferably C₈-C₁₆ alkyl, but are not both hydrogen, and X and Y can be alkali metal ions and/or ammonium ions. It is common to use technical-grade mixtures containing from 50 to 90% by weight of the monoalkylated product, an example being Dowfax® 2A1 (R¹=C₁₂ alkyl; DOW CHEMICAL). The compounds I are known generally, for example, from U.S. Pat. No. 4,269,749, and are obtainable commercially.

Suitable nonionic emulsifiers are araliphatic or aliphatic nonionic emulsifiers, examples being ethoxylated mono-, di- and trialkylphenols (EO units: 3 to 50, alkyl: C₄-C₉), ethoxylates of long-chain alcohols (EO units: 3 to 50, alkyl: C₈-C₃₆), and polyethylene oxide/polypropylene oxide block copolymers. Preference is given to aliphatic emulsifiers, e.g., ethoxylates of long-chain alcohols (alkyl: C₁₀-C₂₂, average degree of ethoxylation: from 3 to 50) and, of these, particular preference is given to those based on naturally occurring alcohols or on oxo alcohols having a linear or branched C₁₂-C,₈ alkyl radical and a degree of ethoxylation from 8 to 50.

The dispersions of the polymer P preferably include at least one anionic emulsifier, preference being given to compounds of the formula I and to the abovementioned alkyl sulfates, especially the sodium salts. Combinations of compounds of the formula I and alkyl sulfates are preferred. The amount of anionic emulsifiers is preferably at least 0.5% by weight, in particular at least 1% by weight, and with particular preference at least 2% by weight. Preferably, it will not exceed 5% by weight.

Moreover, it has been found advantageous for the surface-active substances used for stabilization to include not only the abovementioned anionic emulsifiers but also nonionic emulsifiers, preferably in amounts of at least 0.5% by weight and in particular at least 0.5% by weight, for example, in amounts of from 0.3 to 5% by weight and in particular from 0.5 to 3% by weight. With particular preference, the weight ratio of anionic to nonionic emulsifiers is situated within the range from 10:1 to 1:2 and in particular within the range from 5:1 to 1:1.

Further suitable emulsifiers may be found in Houben-Weyl, Methoden der organischen Chemie, volume XIV/1, Makromolekulare Stoffe [Macromolecular Substances], Georg-Thieme-Verlag, Stuttgart, 1961, pp. 192-208).

The emulsion polymerization may be conducted either continuously or batchwise, preferably by a semicontinuous process. In the case of semicontinuous processes, the majority, i.e., at least 70%, preferably at least 90%, of the monomers to be polymerized are supplied to the polymerization batch continuously, including staged or gradient procedures. This process is also known as the monomer feed technique. The monomer feed comprises liquid monomer mixtures, monomer solutions or, in particular, aqueous monomer emulsions, which include some or all of the surface-active substance required.

In addition to the seed-free mode of preparation it is also possible, in order to establish a defined polymer particle size, to conduct the emulsion polymerization in accordance with the seed latex technique or in the presence of seed latex prepared in situ. Techniques for doing this are known and can be found in the prior art (see EP-B 40419, EP-A-614 922, EP-A-567 812 and literature cited therein, and ‘Encyclopedia of Polymer Science and Technology’, Vol. 5, John Wiley & Sons Inc., New York 1966, p. 847).

The polymerization is preferably conducted in the presence of from 0.01 to 3% by weight and in particular from 0.02 to 1.5% by weight of a seed latex (solids content of a seed latex, based on overall monomer amount), preferably with seed latex introduced in the initial charge (initial-charge seed). The seed latex may also be produced in situ from the monomers to be polymerized, by initially introducing a small amount of the monomers to be polymerized in the form of an aqueous emulsion together with a portion of the surface-active substance, heating this emulsion to polymerization temperature, and then adding a portion of the initiator.

The temperature and pressure of polymerization are of minor importance. It is generally conducted at temperatures between room temperature and 120° C., preferably at temperatures from 40 to 95° C., and with particular preference between 50 and 90° C.

Following the polymerization reaction proper it is generally necessary to free the aqueous polymer dispersions of the invention substantially from odoriferous substances, such as residual monomers and other volatile organic constituents. This can be done in a manner known per se physically, by distillative removal (especially by way of steam distillation), or by stripping with an inert gas. The residual monomers may also be reduced in amount chemically, by means of free-radical postpolymerization, especially under the action of redox initiator systems, as set out, for example, in DE-A 44 35 423, DE-A 44 35 422 or DE-A 44 19 518. The postpolymerization is preferably conducted with a redox initiator system comprising at least one organic peroxide and one organic sulfite.

Suitable peroxides for the redox-initiated postpolymerization include, in particular, besides hydrogen peroxide, also tert-butyl hydroperoxide, cumene hydroperoxide and alkali metal peroxodisulfates, such as sodium and ammonium peroxodisulfate. Examples of suitable reductants are sodium disulfite, sodium hydrogen sulfite, sodium dithionite, sodium hydroxymethanesulfinate, formamidinesulfonic acid, ascorbic acid, acetone bisulfite adduct, reductive sugar compounds or water-soluble mercaptans, e.g., 2-mercaptoethanol, particular preference being given to ascorbic acid. For the redox-initiated postpolymerization, the redox system is admixed if desired with a soluble salt of a metal of changing valence, e.g., iron, copper or vanadium salts, and, if desired, complexing agents such as EDTA. The redox-initiated postpolymerization takes place preferably at temperatures in the range from 10 to 100° C., in particular from 20 to 90° C. The postpolymerization generally takes place over a period of from 10 minutes to 4 hours. The initiator for the postpolymerization may be added in one or more portions, dissolved or undissolved, or continuously. In the redox-initiated postpolymerization, the redox partners are preferably added separately from one another. It is preferred to combine chemical and physical deodorization with one another, i.e., simultaneously or, preferably, in succession. In particular it is advisable first to carry out chemical deodorization and then physical deodorization.

Before being used in the formulations of the invention, the aqueous dispersions of the polymer P are preferably adjusted to a pH in the range from 6 to 10, preferably by adding a nonvolatile base, examples of such bases being alkali metal or alkaline earth metal hydroxides, or nonvolatile amines.

By the method of emulsion polymerization it is possible in principle to obtain dispersions having solids contents of up to about 80% by weight (polymer content based on the overall weight of the dispersion). Taking into account practical considerations, polymer dispersions having solids contents in the range from 40 to 70% by weight are generally preferred for the formulations of the invention. Particular preference is given to dispersions having polymer contents of about 45 to 60% by weight. Dispersions having lower solids contents are of course also suitable in principle for the coating compositions of the invention.

In accordance with the invention, the polymers P in the form of their aqueous polymer dispersions are used as binders in pigmented formulations that are used to coat substrates (pigmented coating compositions). By such formulations are meant polymer dispersion plasters and paints, i.e., emulsion paints, especially paints for exterior application (known as masonry paints).

The coatings obtainable from these compositions are particularly notable for especially good weathering stability, especially on frost exposure; in other words, the paints in particular show no delamination (in the form of blistering, for example) when exposed to frost in a humid atmosphere. Moreover, polymer films of the polymers P used as binders in the coating compositions of the invention show relatively little tendency to absorb water or to exhibit blushing.

The coating compositions of the invention, preferably the emulsion paints, contain generally from 30 to 75% by weight and preferably from 40 to 65% by weight of nonvolatile constituents. These include all constituents of the formulation other than water, but at least the overall amount of binder (component I), pigment (component II), filler (component III), and polymeric auxiliaries (component IV). Of this overall amount, approximately

i) from 5 to 40% by weight is accounted for by solid binder constituents (polymer P),

ii) from 10 to 30% by weight is accounted for by at least one inorganic pigment,

iii)from 15 to 60% by weight is accounted for by inorganic fillers, and

iv) from 0.1 to 20% by weight, preferably from 0.5 to 10% by weight, is accounted for by customary auxiliaries,

the pigment volume concentration PVC of the coating compositions being—in accordance with the invention—at least 20 and generally not exceeding 65. In coating compositions in the form of emulsion paints for exterior applications, the PVC is preferably in the range from 20 to 60 and in particular in the range from 30 to 60, and especially in the range from 35 to 59.

Typical pigments II for the formulations of the invention, especially for emulsion paints, are white pigments such as titanium dioxide, preferably in the rutile form, barium sulfate, and zinc oxide. The formulations may, however, also include color pigments, examples being iron oxides, carbon black, luminescent pigments, zinc yellow, zinc green or ultramarine. The preferred white pigment is titanium dioxide.

Suitable fillers III include alumosilicates, such as feldspars, silicates, such as kaolin, talc, mica, wollastonite, magnesite, alkaline earth metal carbonates, such as calcium carbonate, in the form for example of calcite or chalk, magnesium carbonate, dolomite, alkaline earth metal sulfates, such as calcium sulfate, silicon dioxide, Plastorit®, etc. The fillers may be used as individual components. In practice, however, it has been found particularly appropriate to use mixtures of fillers, e.g., calcium carbonate/kaolin, calcium carbonate/talc.

In order to increase the hiding power and to save on the use of white pigments, it is common in emulsion paints with supercritical formulation (highly filled paints; PVC>critical PVC) to use finely divided fillers, an example being finely divided calcium carbonate or mixtures of various calcium carbonates with different particle sizes. To adjust the hiding power, shade and depth of color, it is preferred to employ blends of color pigments and fillers.

The customary auxiliaries IV include wetting agents and dispersants, such as sodium, potassium or ammonium polyphosphates, alkali metal salts and ammonium salts of polyacrylic acids and of polymaleic acid, polyphosphonates, such as sodium 1-hydroxyethane-1,1-diphosphonate, and also salts of naphthalenesulfonic acids, especially the sodium salts thereof. The dispersants are generally used in an amount of from 0.1 to 0.6% by weight, based on the overall weight of the emulsion paint. The auxiliaries IV generally further include defoamers, preservatives, hydrophobicizing agents, biocides, fibers, or further constituents.

Furthermore, the auxiliaries IV may also include thickeners, examples being cellulose derivatives, such as methylcellulose, hydroxyethylcellulose and carboxymethylcellulose, and also casein, gum arabic, tragacanth gum, starch, sodium alginate, polyvinyl alcohol, polyvinylpyrrolidone, sodium polyacrylates, water-soluble copolymers based on acrylic and methacrylic acid, such as acrylic acid/acrylamide copolymers and methacrylic acid/acrylate copolymers, and what are known as associative thickeners, examples being styrene-maleic anhydride polymers, special polyacrylate thickeners, hydrophobically modified cellulose or, preferably, hydrophobically modified polyetherurethanes, as described, for example, by N. Chen et al. in J. Coatings Tech., 69 (1997), No. 867 on p. 73 and by R.D. Hester et al. in J. Coatings Technology 69 (1997) No. 864 on page 109, and whose disclosure content is hereby incorporated fully by reference. Inorganic thickeners as well, such as bentonites or hectorite, may be used. Thickeners are used generally in amounts of from 0.1 to 3% by weight, preferably from 0.1 to 1% by weight, based on the overall weight of the aqueous formulation.

The coating compositions of the invention are stable fluid systems which can be used to coat a large number of substrates. Examples of suitable substrates include wood, concrete, metal, glass, ceramics, plastic, plasters, wallpapers, and other painted, primed or weathered substrates. The application of the coating composition to the substrate that is to be coated takes place in a manner dependent on the configuration of the formulation. Depending on the viscosity and pigment content of the formulations and on the substrate, application may take place by rolling, brushing, knife coating or spraying. The coating compositions of the invention may be used both as topcoat paint for primed and unprimed substrates and also as primer compositions, the latter generally having a relatively low solids content.

In accordance with the definition, the coating compositions of the invention include plasters bound with synthetic resin. These generally have a higher filler content and lower pigment and binder content. The synthetic-resin-bound plasters include, for example, brushable plasters, rubbing plasters, troweling plasters, and colored stone plasters. The PVC of such plasters is generally more than 60, in particular more than 65.

Depending on the nature of the plaster of the invention, it contains the abovementioned fillers in amounts of from 60 to 90% by weight, in particular from 75 to 90% by weight, polymer P in amounts of from 5 to 15% by weight, pigments in amounts of from 0 to 10% by weight, e.g., from 1 to 10% by weight, and auxiliaries in amounts of from 0.1 to 15% by weight, based in each case on the overall weight of the nonvolatile constituents in the coating composition.

In addition to the abovementioned fillers, the plasters may also include relatively coarse filler constituents, e.g., colored silicates or quartz particles in the case of colored-stone plasters, or glass fibers in the case of troweling plasters.

The coating compositions of the invention additionally include highly filled emulsion paints having a PVC of more than 65, in particular of more than 70. Coating compositions of this kind are notable for improved washing and scrubbing resistance and, for example, meet the DIN standard 53778 part 2 for wash resistance even without the addition of film-forming auxiliaries.

The coating compositions of the invention are notable for good weathering stability, especially under frost exposure. Furthermore, the coating compositions of the invention feature low odor, soil pickup resistance, water resistance, and a high level of scrub resistance.

The examples below are intended to illustrate the invention, though without restricting it.

I. Preparation and characterization of the polymer dispersions (polymers P)

The average particle size (z-average) of the polymer particles was measured by dynamic light scattering (photon correlation spectroscopy) on a 0.01% by weight dispersion in water at 23° C. using an Autosizer IIc from Malvern Instruments, UK. The value reported is the cumulant z-average diameter of the measured autocorrelation function.

The minimum film formation temperature (MFFT) of the polymer dispersions was measured in accordance with Ullmanns Enzyklopadie der technischen Chemie, 4th edition, vol. 19, VCH Weinheim 1980, p. 17. The measuring instrument used was a film former bar (a metal plate to which a temperature gradient is applied and on which temperature sensors are mounted at various points for temperature calibration, the temperature gradient being chosen so that one end of the film former bar has a temperature above the expected MFFT and the other end has a temperature below the expected MFFT). The aqueous polymer dispersion is applied to the film former bar. In those regions of the film former bar whose temperature is above the MFFT, a clear film is formed on drying, whereas in the cooler regions cracks appear in the film and at even lower temperatures a white powder is formed. The MFFT is determined visually on the basis of the known temperature profile of the plate.

I. Preparation of the binder dispersions P1 to P4

A 2 1 glass reactor was charged with 32 g of a 33% seed latex in 250 g of deionized water and with 6.6 g of a 5% strength solution of sodium peroxodisulfate in deionized water and this initial charge was heated to 95° C. Subsequently, an emulsion of 284 g of deionized water, 12.6 g of a 90% strength solution of an octaethoxylated iso-C₁₃ oxo alcohol, 16.7 g of a 45% strength solution of Dowfax® 2A1 (Dow Chemical), 25 g of a 15% strength solution of sodium lauryl sulfate, 15 g of a 50% strength solution of acrylamide,×g of methyl methacrylate, y g of 2-ethylhexyl acrylate and z g of acrylic acid, and a solution of 1.7 g of sodium peroxodisulfate in 58 g of deionized water, were run in over 180 minutes. Following a postpolymerization period of 30 minutes, 0.55 g of a 70% strength solution of tert-butyl hydroperoxide in 3.5 g of DI water and 0.38 g of ascorbic acid in 20 g of DI water were run in at 90° C. over the course of one hour, and the pH of the samples was adjusted to 7. The resulting dispersion was then treated with steam in a circulation deodorization, after which it was cooled to room temperature. The starting materials are specified in Table 1. The MFFT of all polymers was below 3° C.

TABLE 1

| | P 1 | P 2 | P 3 | P 4 |
|---|---|---|---|---|
| x [g] | 362.6 | 363.8 | 362.6 | 362.6 |
| y [g] | 377.6 | 378.8 | 377.6 | 377.6 |
| z [g]/% | 3.75/0.51 | 0/0 | 5.6/0.75 | 7.5/1.0 |
| Solids con- | 52.9 | 52.5 | 53.1 | 52.5 |
| tent (%) | | | | |
| Particle | 131 | 129 | 131 | 132 |
| size (nm) | | | | |

II. Preparation of the inventive coating compositions (examples 1 to 3, comparative example 1)

A pigment paste was prepared from 623 g of water, 14 g of dispersing auxiliary¹), 28 g of a 25% strength aqueous sodium polyphosphate solution²), 21 g of preservative³), 14 g of defoamer⁴), 420 g of a 2% strength aqueous hydroxyethylcellulose solution⁵), 14 g of a 20% strength solution of NaOH, 1099 g of titanium oxide⁶), 1274 g of calcium carbonate⁷) and 392 g of Micro Talc⁸). To 278.5 g of the paste were then added u g of polymer dispersion, 0.5 g of defoamer⁴), and v g of a 5% strength aqueous solution of an associative thickener⁹) and w g of deionized water. The amounts u, v and w are specified in Table 2.

1) Pigmentverteiler S: 30% strength by weight sodium polyacrylate solution (BASF Aktiengesellschaft)

2) Calgon® N; BK Ladenburg, Ladenburg, Germany

3) Parmetol A26 from Schultze und Mayr GmbH, Norderstedt

4) Agitan® 280; Munzig Chemie GmbH, Heilbronn

5) aqueous hydroxyethylcellulose solution; Natrosolo 250HR; Hercules GmbH, Dusseldorf (thickener)

6) titanium pigment rutile type; Kronos 2190 from Kronos Titan GmbH, Leverkusen

7) omyacarb 5 GU; Omya GmbH, Cologne

8) Micro Talc AT1 (manufacturer: Norwegian Talc Deutschland GmbH, Bad Soden-Salmunster)

9) Acrysol® TT-935; Rohm & Haas Deutschland GmbH, Frankfurt. III Performance testing

a) Freeze/thaw testing

The paints obtained in accordance with II were applied in three coats in a total amount of 300 g/m². As the 1st coat, the paint diluted with water in a ratio of 1:1 was applied.

The 2nd and 3rd coats were produced by applying the undiluted paint. Coats were left to dry for 24 h between each paint application.

The coated plate was then stored in water for 7 h, then at −20° C. for 16 h with a water vessel, after which the sample was thawed and its appearance assessed. This was repeated twice (2nd and 3rd freeze/thaw cycle).

b) Water absorption

To determine the water absorption, a polymer film was cast from the polymer dispersions obtained in accordance with I. This film was dried, weighed, and then stored in water for 24 h. Following removal of adhering water droplets, the resulting polymer films were weighed. The increase in weight, in % based on the initial weight, is reported in Table 2.

The blistering, delamination and cracking were assessed in accordance with a rating system. In this system, rating 0=perfect condition, rating 1=slight blistering, rating 2=marked blistering, rating 3=blistering, incipient delamination, rating 4=isolated instances of delamination, rating 5=extensive delamination.

The results are summarized in Table 2. Tests were carried out in duplicate in each case.

TABLE 2

| | | | | Comparative |
|---|---|---|---|---|
| | Example 1 | Example 2 | Example 3 | example |
| u [g] | 185 | 187 | 180 | 182 |
| v [g] | 17 | 9 | 20 | 25 |
| w [g] | 19 | 25 | 21 | 14 |
| 1st Freeze/ | 0/0 | 0/0 | 0/0 | 5/5 |
| thaw | | | | |
| cycle¹⁾ | | | | |
| 2nd Freeze/ | 2/1 | 3/4 | 2/4 | 5/5 |
| thaw | | | | |
| cycle¹⁾ | | | | |
| 3rd Freeze/ | 3/1 | 3/4 | 2/4 | 5/5 |
| thaw | | | | |
| cycle¹⁾ | | | | |
| Water absorp- | 10.2 | 9.1 | 10.5 | 14.3 |
| tion²) [%] | | | | |

¹⁾Determined on paint formulation
²⁾Determined on polymer

We claim:

1. A water-based, pigmented coating composition essentially free from volatile organic compounds and comprising
i) an aqueous binder formulation as component I, with a minimum film formation temperature MFFT <50C, based on an aqueous polymer dispersion of one or more polymers P composed of
from 90 to 99.9% by weight of at least two different monomer varieties A1 and A2, the monomer A1 being selected from the C₂-C₁₂ alkyl esters of acrylic acid and the monomer A2 being selected from the C₁-C₁₂ alkyl esters of methacrylic acid;
from 0 to <1% by weight of monomers B, selected from monoethylenically unsaturated monocarboxylic acids having 3 to 6 carbon atoms;
from 0 to 0.5% by weight of monomers C, selected from monoethylenically unsaturated dicarboxylic acids having 4 to 6 carbon atoms and ethylenically unsaturated sulfonic acids;
from 0 to 2% by weight of monomers D, selected from the amides of monoethylenically unsaturated monocarboxylic acids having 3 to 6 carbon atoms;
from 0 to 5% by weight of monomers E, selected from the C₂-C₄ hydroxyalkyl esters of monoethylenically unsaturated monocarboxylic acids having 3 to 6 carbon atoms (monomers El) and the esters of monoethylenically unsaturated monocarboxylic acids having 3 to 6 carbon atoms with poly(C₂-C₃ alkylene oxides) (monomers E2), and
from 0 to 5% by weight of monomers F, selected from monoethylenically unsaturated monomers having a urea group and monoethylenically unsaturated monomers having an acetylacetoxy group (CH₃C(O)CH₂C(O)—O— group),
all proportions of the monomers being based on the overall amount of the monomers A to F;
the overall amount of the monomers B and C being less than 1% by weight; and
the overall amount of the monomers B, C, D, E and F being from 0.1 to 10% by weight;
ii) at least one inorganic particulate pigment as component II,
iii)if desired, inorganic particulate fillers as component III, and
iv) the auxiliaries typical of coating compositions, the coating composition containing less than 0.05% by weight, based on the polymer P, of photoinitiators and being characterized by a pigment volume concentration PVC of more than 20.

2. A coating composition as claimed in claim 1, wherein the monomers A1 are selected from ethyl acrylate, n-butyl acrylate and 2-ethylhexyl acrylate and the monomers A2 are selected from methyl methacrylate and n-butyl methacrylate.

3. A coating composition as claimed in claim 1, wherein the polymer P contains as monomer B from 0.1 to 0.8% by weight of acrylic acid and/or methacrylic acid in copolymerized form.

4. A coating composition as claimed in claim 1, wherein the polymer P contains from 0.2 to 2% by weight of at least one monomer D and/or from 0.2 to 4% by weight of at least one monomer E in copolymerized form.

5. A coating composition as claimed in claim 1, wherein component I is obtainable by free-radical aqueous emulsion polymerization of the monomers A to F in the presence of one or more surface-active compounds, comprising at least one anionic emulsifier and, if desired, one or more nonionic emulsifiers.

6. A coating composition as claimed in claim 5, wherein following the emulsion polymerization component I has been adjusted to a pH of from 6 to 10 using nonvolatile base.

7. A coating composition as claimed in claim 1, containing less than 0.1% by weight of volatile organic constituents (based on the overall amount of the coating composition).

8. A coating composition as claimed in claim 1, having a PVC in the range from 20 to 65, in particular from 30 to 60.

9. A coating composition as claimed in claim 1, in the form of an emulsion paint for exterior applications.

10. A coating composition as claimed in claim 8, comprising as nonvolatile constituents
i) from 5 to 40% by weight of component I
ii) from 10 to 30% by weight of component II
iii) from 15 to 60% by weight of component III
iv) from 0.1 to 20% by weight of the auxiliaries customary for coating compositions.
